(19) United States
(12) Patent Application Publication
(10) Pub. No.: US 2007/0217389 A1
(43) Pub. Date: Sep. 20, 2007

(54) Apparatus and method for processing data in a wireless network

(75) Inventors: Chang-Woo Seo, Suwon-si (KR); Hyeong-Seok Yu, Seoul (KR); Jae-Kon Lee, Suwon-si (KR); Min-Young Ahn, Seongnam-si (KR); Gang-Youl Yu, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/714,067

(22) Filed: Mar. 5, 2007

(30) Foreign Application Priority Data
Mar. 4, 2006 (KR) 20734/2006

(51) Int. Cl. H04J 1/16; H04J 3/24

(52) U.S. Cl. 370/349; 370/252

(57) ABSTRACT

Provided is an apparatus and method for processing data in a wireless network. The method includes receiving packet data transmitted in a downlink transmission interval, determining whether a current state is one in which processing of the packet data is possible; and if processing of the packet data is not possible, writing a pause bit for requesting hold of packet data transmission in a reserved bit of a Medium Access Control (MAC) header before transmission.

MS for performance improvement. Therefore, a scheme is needed for efficiently using the limited capability of the MS.

For example, as storage capacity of a reception buffer is limited, there is a limitation in the possible amount of downlink data stored in the reception buffer. If a downlink frame is received in a state where overflow occurs in the reception buffer, the MS cannot process the corresponding downlink frame. In this situation, the existing MS transmits to the BS a response message indicating its failure to process the corresponding downlink frame. The BS retransmits the corresponding downlink frame upon receipt of the response message indicating that the MS has failed to normally receive the corresponding downlink frame.

The downlink frame retransmitted from the BS may cause an increase in load of a reception buffer in the MS. In the worst case, the excessive load of the reception buffer may affect the data previously normally stored therein.

Accordingly, there is a need for a scheme for preventing a load from additionally occurring in the reception buffer due to the possible overflow of the reception buffer in the MS.

### SUMMARY OF THE INVENTION

An aspect of the present invention is to address at least the problems and/or disadvantages and to provide at least the advantages described below. Accordingly, an aspect of the present invention is to provide an apparatus and method for estimating a state of a reception buffer and controlling transmission of a data frame depending on the estimated state of the reception buffer in a wireless network.

Another aspect of the present invention is to provide an apparatus and method in a wireless network for determining by a transmission side whether to transmit data according to whether a reception side can receive the data.

A further aspect of the present invention is to provide an apparatus and method in a wireless network for determining by a reception side whether a transmission side can transmit data depending on a state of its reception buffer.

Yet another aspect of the present invention is to provide an apparatus and method in a wireless network for restarting data transmission if data reception at a reception side is possible when data transmission of a transmission side is temporarily stopped (held).

According to the present invention, there is provided a method for processing data in a wireless network. The method includes receiving packet data transmitted in a downlink transmission interval, determining whether a current state is a state in which processing of the packet data is possible, and if processing of the packet data is not possible, writing a pause bit for requesting hold of packet data transmission in a reserved bit of a Medium Access Control (MAC) header before transmission.

The packet data transmission hold request is transmitted such that it can be received at a transmission side before a packet data transmission attempt that is periodically made by the transmission side.

The packet data transmission hold request is transmitted in an initial packet data processing not possible state, and if transition occurs from the packet data processing not possible state to a packet data processing possible state, the pause bit for requesting hold of packet data transmission is not written in the reserved bit of the MAC header before transmission.

The transmission side releases a transmission hold state and then restarts packet data transmission if a mean delay time of a traffic type for each connection has elapsed after the packet data transmission hold request is received.

The packet data processing possible state indicates a state in which an empty space of a reception buffer is sufficient to store the received packet data.

According to the present invention, there is provided an apparatus for processing data in a wireless network. The apparatus includes a reception buffer for storing packet data transmitted in a downlink transmission interval, a packet processor for determining whether a current state is a state in which processing of packet data provided through the reception buffer is possible, and ordering transmission of a response message for requesting hold of packet data transmission with a reserved bit of a Medium Access Control (MAC) header if processing of the packet data is not possible, and a MAC header generator for writing the pause bit for requesting hold of packet data transmission in the reserved bit of the MAC header before transmission in response to an order from the packet processor.

The packet data transmission hold request is transmitted such that it can be received at a transmission side before a packet data transmission attempt that is periodically made by the transmission side.

The packet data transmission hold request is transmitted in an initial packet data processing impossible state, and if transition occurs from the packet data processing not possible state to a packet data processing possible state, the pause bit for requesting hold of packet data transmission is not written in the reserved bit of the MAC header before transmission.

The transmission side releases a transmission hold state and then restarts packet data transmission if a mean delay time of a traffic type for each connection has elapsed after the packet data transmission hold request is received.

The packet data processing possible state indicates a state in which an empty space of the reception buffer is sufficient to store the received packet data.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a procedure for processing packet data according to the present invention;

FIG. 2 illustrates a procedure for processing packet data and voice data according to the present invention;

FIG. 3 illustrates a data processing scenario according to the present invention;

FIG. 4 illustrates state transition of a transmission apparatus according to the present invention;

FIG. 5 illustrates state transition of a reception apparatus according to the present invention; and

FIG. 6 illustrates a structure of a reception apparatus according to the present invention.

### DETAILED DESCRIPTION OF THE PREFERRED EMBODIMENTS

Preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for the sake of clarity and conciseness.

In the following description of the present invention, only the downlink is considered. That is, the present invention will be applied only to a reception buffer of an MS, by way of example. However, it would be obvious to those skilled in the art that the present invention can also be applied to an uplink, i.e. a BS.

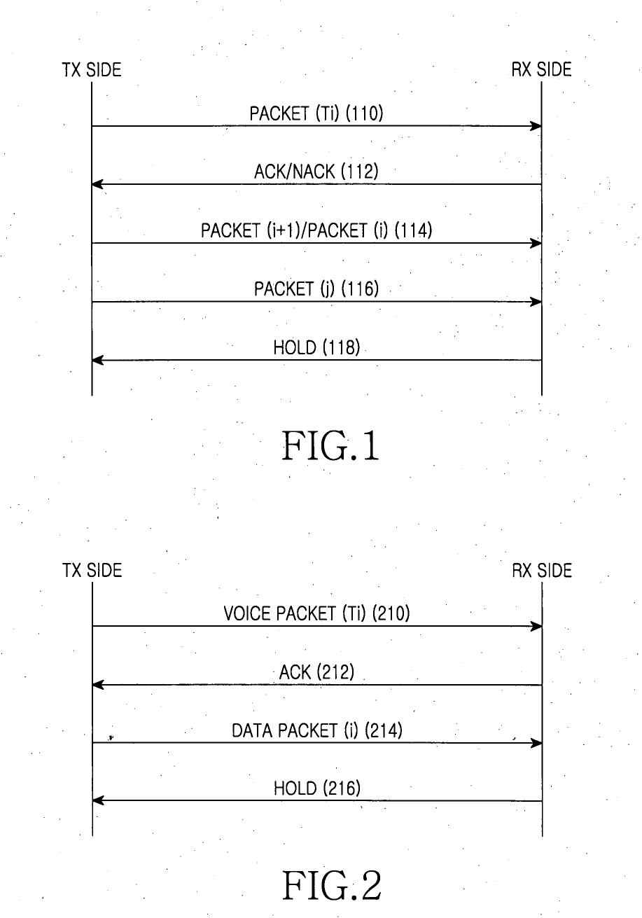

FIG. 1 illustrates a procedure for processing packet data according to the present invention.

Referring to FIG. 1, a transmission side (TX) transmits packet data to a reception side (RX) in step 110. The reception side receives in step 112 the packet data and transmits the reception result (ACK/NACK) to the transmission side. The transmission side determines data reception success/failure depending on the reception result.

The transmission side transmits packet data in steps 114 and 116. Assuming that the reception side is in the state in which it cannot receive data due to the packet data received in step 116, the reception side cannot store any more data due to expected overflow of its reception buffer.

In the state in which it can receive no more data, the reception side transmits in Step 118 a HOLD message for requesting the holding (temporary stop) of packet data transmission, to the transmission side. The transmission side receiving the HOLD message holds (temporarily stops) the transmission of packet data until the reception side transitions to the state in which it can receive data again.

FIG. 2 illustrates a procedure for processing packet data and voice data according to the present invention.

Referring to FIG. 2, if a Quality-of-Service (QoS)-requiring packet (for example, voice packet) is received, a reception side performs give-up processing on the received packet, and sends no request for the holding of data transmission to a transmission side. In this manner, for the voice data, the reception side checks a Constant Bit Rate (CBR) thereof and disregards a loss of the voice packet according to the check result (Steps 210 and 212).

However, if a non-QoS-requiring packet (for example, data packet) is received in the state in which it cannot receive data, the reception side discards the received packet, and transmits to the transmission side a HOLD message for requesting the holding of the packet transmission (Steps 214 and 216). The transmission side receiving the HOLD message holds the packet transmission.

The data transmission hold state in the transmission side can be determined in the following methods.

In a first method, the reception side continuously transmits a HOLD message before a frame transmission time of the transmission side, thereby maintaining the frame transmission hold state of the transmission side. In the meantime, in the state in which it can receive data, the reception side no longer transmits the HOLD message, thereby allowing the transmission side to transition to a transmission state in which it can normally transmit data.

In a second method, the reception side transmits a HOLD message to the transmission side when it can no longer receive data. The transmission side receiving the HOLD message holds data transmission and maintains the data transmission hold state. In the meantime, in the state in which it can receive data again, the reception side transmits a HOLD OFF message for releasing the data transmission hold state to the transmission side. Upon receipt of the HOLD OFF message from the reception side, the transmission side transitions to a transmission state, in which it restarts the held data transmission.

In a third method, the reception side transmits a HOLD message to the transmission side when it can no longer receive data. The transmission side receiving the HOLD message holds the data transmission and maintains the data transmission hold state. If a mean delay time of a traffic type for each set connection has elapsed from the data transmission hold time, the transmission side transitions to the transmission state, in which it restarts the data transmission. In this method, the transmission side transitions from the HOLD state to the transmission state.

The reception side can expect to be in the state in which it cannot receive packets, in the following cases. The reception side determines that it is in the state in which it cannot receive packets, if an empty space of a reception buffer included in the reception side is less than the minimum packet length specified in the wireless link. In addition, the reception side determines that it is in the state in which it cannot receive packets, if its mean bus processing time is less than a rate of a received packet in the state in which the empty space of the reception buffer included in the reception side is less than the maximum packet length specified in the wireless link.

The reception side can expect not to receive packets, with use of a functional formula for comparing trends of inflows and outflows to/from a buffer of the reception side.

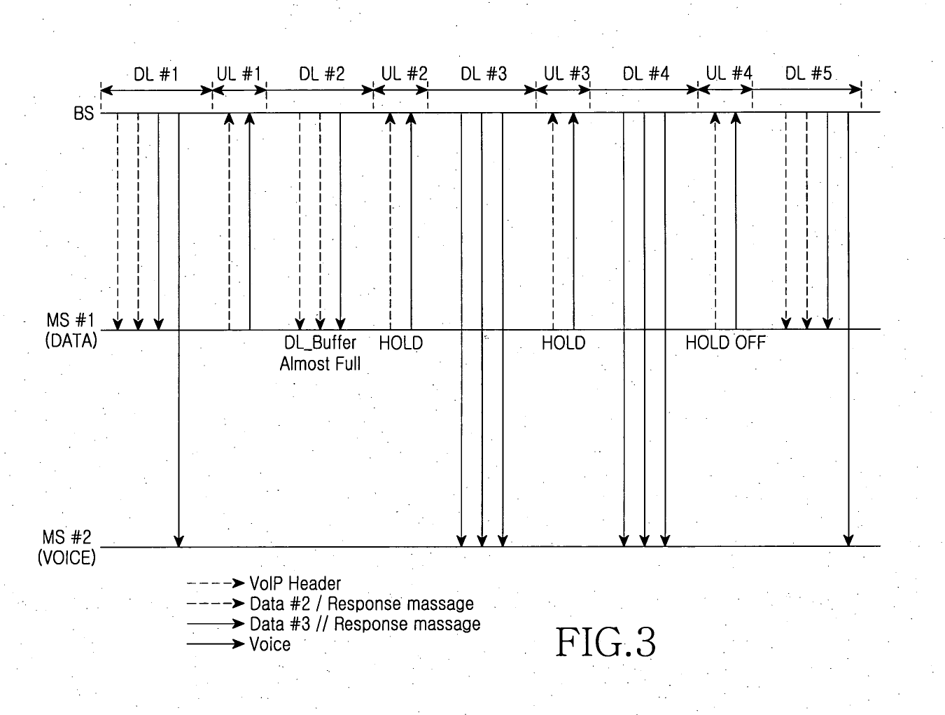

FIG. 3 illustrates a data processing scenario according to the present invention. It is assumed in FIG. 3 that a transmission side is a BS and a reception side includes an MS#1 and MS#2. In addition, the MS#1 is assumed as a terminal (for example, notebook computer) for receiving data, and the MS#2 is assumed as a terminal (for example, mobile phone) for receiving voice.

Referring to FIG. 3, a BS transmits two data frames including a Voice over Internet Protocol (VoIP) header and one voice frame in a first DownLink interval DL#1. The two data frames are received at an MS#1, and the voice frame is received at an MS#2. The MS#1 transmits a response message in response to each of the received data frames in a first UpLink interval UL#1. The transmitted response message can be an ACKnowledge (ACK) message for reporting normal receipt of the data frame.

The BS transmits two data frames including a VoIP header in a second DownLink interval DL#2. The two data frames are received at the MS#1. However, MS#1 may encounter a situation (DL_Buffer Almost Full) in which it can no longer receive data frames when it receives the two data frames. A typical example of this situation is when MS#1 cannot store the received data frames in its reception buffer.

In this situation, MS#1 transmits to the BS a HOLD message for requesting the holding of transmission of the data frames. The HOLD message can be transmitted using a general uplink MAC Protocol Data Unit (PDU) header. In this case, a pause bit(s) is added to reserved bits of the MAC header.

Upon receiving the HOLD message for requesting the holding of transmission of the data frames from MS#1, the BS no longer transmits the data frames. Therefore, the BS transmits only three voice frames in a third DownLink interval DL#3. The three voice frames are received at MS#2. MS#1 determines whether it can receive data frames in DL#3 as the situation in which it cannot receive data frames is released. If the situation in which it cannot receive data frames is maintained, MS#1 sends a request for the holding of data frame transmission even in a third UpLink interval UL#3.

Therefore, the BS transmits only four voice frames even in a fourth DownLink interval DL#4. The four voice frames are received at MS#2. MS#1 determines whether it can receive data frames in DL#4 as the situation in which it cannot receive data frames is released. If it can receive data frames, MS#1 sends a request for releasing the holding of data frame transmission in a fourth UpLink interval UL#4. The request message for releasing the holding of data frame transmission can be a MAC header with an unset pause bit.

Upon receipt of a request for restarting the data frame transmission from MS#1, the BS transmits two data frames including a VoIP header and one voice frame in a fifth DownLink interval DL#5. The two data frames are received at MS#1, and the voice frame is received at MS#2.

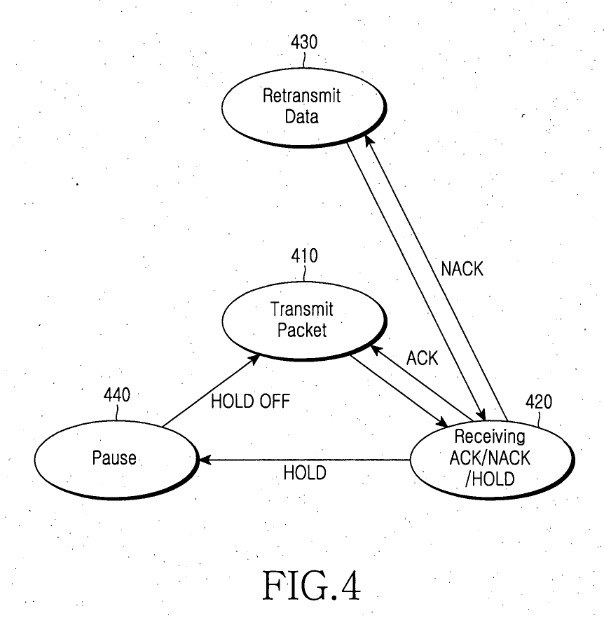

FIG. 4 illustrates state transition of a transmission apparatus according to the present invention.

Referring to FIG. 4, a transmission apparatus transmits packet data in a transmission state 410. Thereafter, the transmission apparatus transitions to a response message reception state 420 in which it receives a response message in response to the previously transmitted packet data. In the response message reception state 420, the transmission apparatus can receive one of three types of response messages.

If the transmission apparatus receives an ACK message as the response message, it transitions to the transmission state 410 where it continuously transmits packet data. If the transmission apparatus receives a NACK message as the response message, it transitions to a retransmission state 430 where it retransmits the previously transmitted packet data. After retransmitting the transmission-failed packet data, the transmission apparatus transitions to the response message reception state 420.

If the transmission apparatus receives a HOLD message as the response message, it transitions to a pause state 440 in which the transmission apparatus pauses transmission of packet data and monitors whether a HOLD OFF message for requesting release of the pause state is received from a reception apparatus. Upon receipt of the HOLD OFF message from the reception apparatus, the transmission apparatus transitions to the transmission state 410 where it restarts the packet data transmission.

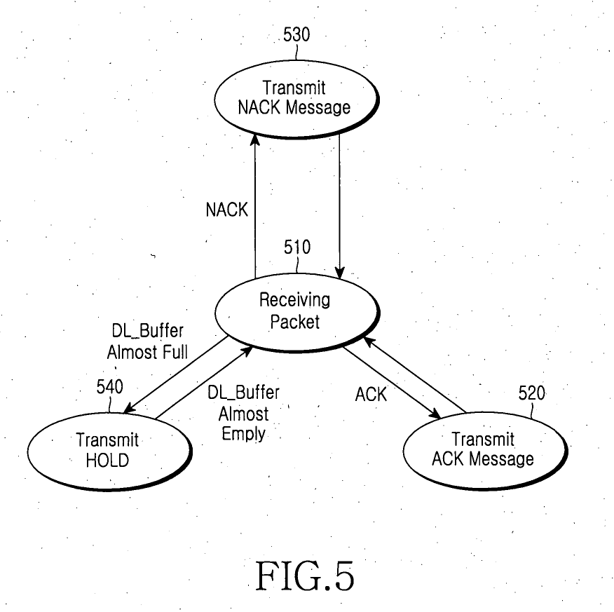

FIG. 5 illustrates state transition of a reception apparatus according to the present invention.

Referring to FIG. 5, a reception apparatus receives packet data transmitted from a transmission apparatus in a reception state 510. Thereafter, the reception apparatus determines whether it has normally received the packet data.

If the reception apparatus has normally received the packet data, it transitions to an ACK message transmission state 520, in which the reception apparatus transmits a response message reporting that it has normally received the previously received packet data. The transmitted response message can be an ACK message.

If the reception apparatus has failed to normally receive the packet data, it transitions to a NACK message transmission state 530, in which the reception apparatus transmits a response message reporting that it has failed to normally receive the previously received packet data. The transmitted response message can be a NACK message.

If the reception apparatus is in a situation (DL_Buffer Almost Full) in which it cannot receive packet data, it transitions to a HOLD message transmission state 540, in which the reception apparatus transmits a response message for requesting the holding of packet data transmission. The transmitted response message can be a MAC header with a set pause bit.

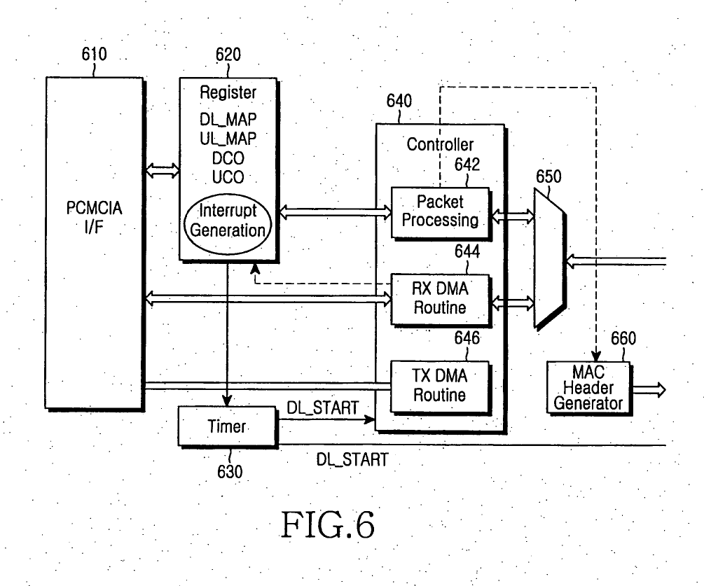

FIG. 6 illustrates a structure of a reception apparatus according to the present invention.

Referring to FIG. 6, packet data is provided to a controller 640 via a downlink buffer (not shown) constituting a physical layer interface (not shown).

A packet processor 642 of the controller 640 processes the provided packet data, and outputs a response control signal corresponding to the processing result. If the received packet data has been normally received, the packet processor 642 outputs a response control signal for ordering transmission of an ACK message. Otherwise, if the received packet data has not been normally received, the packet processor 642 outputs a response control signal for ordering transmission of a NACK message.

If the reception apparatus is in a situation in which it can no longer receive packet data, the packet processor 642 outputs a response control signal for ordering transmission of a HOLD message. The HOLD message is for requesting the holding of packet data transmission to a transmission side.

A MAC header generator 660 generates a response message depending on the response control signal from the packet processor 642. The response message generated by the MAC header generator 660 is transmitted to the transmission side via an uplink buffer (not shown). In particular, upon receipt of a request for transmission of a HOLD message from the packet processor 642, the MAC header generator 660 generates a MAC header to be combined with the data output from a TX Direct Memory Access (DMA) routine 646. Here, a pause bit for requesting the holding of packet data transmission is set in reserved bits of the MAC header generated by the MAC header generator 660.

The elements not described in FIG. 6 are not directly related the present invention, or are equal to the existing elements in both structure and operation.

As can be understood from the foregoing description, according to the present invention, the reception side sends to the transmission side a notification indicating that it cannot process packet data, thereby allowing the transmission side to pause transmission of packet data. In this manner, the present invention can solve the overflow problem which may occur in the reception side, and can prevent waste of downlink resources. In addition, the new packet processing, compared with the existing packet processing, facilitates fast flow control and can be simply applied to a MAC layer. Moreover, the disclosed scheme can be used together with the existing scheme of requesting/allocating resources.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for processing data in a wireless network, the method comprising:
receiving packet data transmitted in a downlink transmission interval;
determining whether a current state is a state in which processing of the packet data is possible; and
writing, if it is determined that processing of the packet data is not possible, a pause bit for requesting hold of packet data transmission in a reserved bit of a Medium Access Control (MAC) header before transmission.

2. The method of claim 1, wherein the packet data transmission hold request is transmitted such that it is received at a transmission side before a packet data transmission attempt that is periodically made by the transmission side.

3. The method of claim 1, wherein the packet data transmission hold request is transmitted in an initial packet data processing not possible state, and if transition occurs from the packet data processing not possible state to a packet data processing possible state, the pause bit for requesting hold of packet data transmission is not written in the reserved bit of the MAC header before transmission.

4. The method of claim 2, wherein the transmission side releases a transmission hold state and then restarts packet data transmission if a mean delay time of a traffic type for each connection has elapsed after the packet data transmission hold request is received.

5. The method of claim 1, wherein the packet data processing possible state indicates a state in which an empty space of a reception buffer is sufficient to store the received packet data.

6. An apparatus for processing data in a wireless network, the apparatus comprising:
a reception buffer for storing packet data transmitted in a downlink transmission interval;
a packet processor for determining whether a current state is a state in which processing of packet data provided through the reception buffer is possible, and ordering transmission of a response message for requesting hold of packet data transmission with a reserved bit of a Medium Access Control (MAC) header if processing on the packet data is not possible; and
a MAC header generator for writing the pause bit for requesting hold of packet data transmission in the reserved bit of the MAC header before transmission in response to an order from the packet processor.

7. The apparatus of claim 6, wherein the packet data transmission hold request is transmitted such that it is received at a transmission side before a packet data transmission attempt that is periodically made by the transmission side.

8. The apparatus of claim 6, wherein the packet data transmission hold request is transmitted in an initial packet data processing not possible state, and if transition occurs from the packet data processing not possible state to a packet data processing possible state, the pause bit for requesting hold of packet data transmission is not written in the reserved bit of the MAC header before transmission.

9. The apparatus of claim 7, wherein the transmission side releases a transmission hold state and then restarts packet data transmission if a mean delay time of a traffic type for each connection has elapsed after the packet data transmission hold request is received.

10. The apparatus of claim 6, wherein the packet data processing possible state indicates a state in which an empty space of the reception buffer is sufficient to store the received packet data.
